(19) United States
(12) Patent Application Publication
(10) Pub. No.: US 2011/0066445 A1
(43) Pub. Date: Mar. 17, 2011

(54) SYSTEMS, APPARATUS, AND METHODS FOR ADVANCED PAYMENT TRACKING FOR HEALTHCARE CLAIMS

(75) Inventors: Cynthia Klain, Mansfield, MA (US); Russell Burt, South Burlington, VT (US); Justin Cozzens, Charlotte, VT (US)

(73) Assignee: GENERAL ELECTRIC COMPANY, Schenectady, NY (US)

(21) Appl. No.: 12/560,028

(22) Filed: Sep. 15, 2009

(51) Int. Cl. G06Q 40/00; G06Q 50/00; G06Q 10/00; G06F 15/16

(52) U.S. Cl. 705/2; 705/4; 705/30; 709/204

(57) ABSTRACT

An example claim payment tracking system includes a data store storing historical data regarding claim submission and payment dates. A claims processor generates a representative period of time from claim submission to payment and, using that representative period of time, calculates an expected remittance payment date for each submitted claim for a payer available for provider review and determines if a payment is before or after the expected remittance payment date for the submitted claim. The claims processor translates the determination of timely payment into a payment status message to the provider for at least one submitted claim to indicate a past due payment or a pending payment approaching the expected remittance payment date for the submitted claim. The system further includes a dashboard interface to display the expected remittance payment date for each submitted claim for a provider.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

The present disclosure generally relates to systems and methods to improve healthcare claim processing and payment in the healthcare industry. Particularly, the present disclosure relates to systems and methods to provide a payment date estimation and notification of payment due to facilitate for improving the efficiency of electronic document retrieval and submission for healthcare claim processing and payment.

In the healthcare industry, a healthcare provider generally submits an invoice for payment to a payer. The healthcare provider can be a doctor's office or hospital, for example. The payer can be an insurance company, for example. In general, the provider submits an invoice to a payer. The payer responds by remitting payment to the provider.

However, the processing of claims by the provider and payer of the claims can result in multiple exchanges of communication between the payers and providers. The processing of claims can be time consuming and lead to delay and/or rejection of payment resulting in delay in revenue collection and/or loss of revenue to the provider. Additionally, medical claim submitters (e.g., medical provider or billing offices) often wait sixty to ninety days after the submission of a medical claim before following up on the status of the claim if the submitter has not received any payment.

### SUMMARY

Certain examples provide systems, methods, apparatus, and articles of manufacture for healthcare claim processing.

Certain examples provide a computer-implemented method to process healthcare claim submission and payment. The method includes retrieving historical data regarding healthcare claim submission and payment dates from a data store via a computer. The historical data includes one or more dates of claim submission and one or more corresponding dates of remittance payment. The method additionally includes generating, using a computer processor, a representative value for a period of time elapsed between date of claim submission and date of remittance payment based on the historical data for a payer. The value transforms the historical data regarding dates of claim submission and remittance payment into a period of time elapsed. The method also includes automatically applying the representative period of time value to each submitted claim for the payer available for provider review via a dashboard interface to calculate an expected remittance payment date for each submitted claim using the computer processor and determining if a payment for each submitted claim is before or after the expected remittance payment date for the submitted claim. The method includes displaying the expected remittance payment date for each submitted claim via the dashboard interface. The method further includes translating the determination of whether a payment for each submitted claim is before or after the expected remittance payment date for the submitted claim into a payment status message to the provider for at least one submitted claim to indicate a past due payment or a pending payment approaching the expected remittance payment date for the submitted claim. In addition, the method includes facilitating, via the dashboard interface, contact by the provider to the payer associated with a submitted claim to inquire about payment remittance for the submitted claim.

Certain examples provide a tangible, computer readable storage medium including a set of instructions for execution by a computer. The set of instructions includes a data store to store historical data regarding healthcare claim submission and payment dates from a data store via a computer. The historical data includes one or more dates of claim submission and one or more corresponding dates of remittance payment. The set of instructions additionally includes a claims processor to generate a value for a representative period of time elapsed between date of claim submission and date of remittance payment based on the historical data for a payer. The value transforms the historical data regarding dates of claim submission and remittance payment into a representative elapsed time period. The claims processor is to apply the representative period of time to each submitted claim for the payer available for provider review to calculate an expected remittance payment date for each submitted claim and determine if a payment for each submitted claim is before or after the expected remittance payment date for the submitted claim. The claims processor is to translate the determination of if a payment for each submitted claim is before or after the expected remittance payment date for the submitted claim into a payment status message to the provider for at least one submitted claim to indicate a past due payment or a pending payment approaching the expected remittance payment date for the submitted claim. The set of instructions further includes a dashboard interface to display the expected remittance payment date for each submitted claim for a provider. The dashboard interface is to facilitate contact by the provider with the payer associated with a submitted claim to inquire about payment remittance for the submitted claim.

Certain examples provide a healthcare claim payment tracking system. The system includes a data store to store historical data regarding healthcare claim submission and payment dates from a data store via a computer. The historical data includes one or more dates of claim submission and one or more corresponding dates of remittance payment. The system additionally includes a claims processor to generate a value for a representative period of time elapsed between date of claim submission and date of remittance payment based on the historical data for a payer. The value transforms the historical data regarding dates of claim submission and remittance payment into a representative elapsed time period. The claims processor is to apply the representative period of time to each submitted claim for the payer available for provider review to calculate an expected remittance payment date for each submitted claim and determine if a payment for each submitted claim is before or after the expected remittance payment date for the submitted claim. The claims processor is to translate the determination of if a payment for each submitted claim is before or after the expected remittance payment date for the submitted claim into a payment status message to the provider for at least one submitted claim to indicate a past due payment or a pending payment approaching the expected remittance payment date for the submitted claim. The system further includes a dashboard interface to display the expected remittance payment date for each submitted claim for a provider. The dashboard interface is to facilitate contact by the provider with the payer associated with a submitted claim to inquire about payment remittance for the submitted claim.

### BRIEF DESCRIPTION OF THE DRAWINGS

FIG. 1 depicts an example healthcare claim system to receive, process, and remind healthcare claims and remittances.

FIG. 2 depicts an example healthcare claim processing apparatus to receive, process, and generate alerts/reminders for healthcare claims and remittances.

FIG. 3 illustrates a flow diagram for a method to manage clinical documents for claims processing in accordance with an embodiment of the present invention.

FIG. 4 depicts an example dashboard interface to review pending claim status and other information.

FIG. 5 illustrates a flow diagram of an example method to process filed claim information in a clinical environment.

FIG. 6 is a block diagram of an example processor system that may be used to implement systems, apparatus, and methods described herein.

The foregoing summary, as well as the following detailed description of certain example embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, a digital video disc (DVD), compact disc (CD), etc. storing the software and/or firmware.

In some examples, an enterprise data interchange system provides features including patient accounting and contract management. Patient accounting features include automatic generation of charges from clinical activities, tight connections to the Admission-Discharge-Transfer (ADT) application ensuring insurance and patient demographic information critical to correct billing are managed proactively, electronic, Health Insurance Portability and Accountability Act (HIPAA) standard, direct-to-payer capabilities which reduce costs and speeds reimbursement, worklists to define the tasks, sequencing and time frames, multiple data elements at the charge and account level for collecting revenue reporting data, flexibility in statement distribution method and format for more “patient-friendly” statements, and checking at various points in the care cycle from an Orders application or at the point of registration.

Contract management provides an ability to build and manage contracts with multiple rate schemes for contracts and terms ranging from simple to complex. Contract management supports management of denials and underpayments, calculates expected payments and adjustments and aids healthcare organization staff in follow-up as well as contract evaluation, renegotiation and profitability analysis. Users can produce bills based on the contracted amount, as well as identify and resolve discrepancies and recover underpayments, for example.

In some examples, an advanced payment tracker functionality calculates an estimated payment date for a medical claim using historical medical claim payment data available through a medical claims clearinghouse. The estimated payment date is provided to the submitter of the medical claim who is also notified if the claim has not been paid by the estimated date. The submitter can follow up on the status of the claim once it has been notified that the claim payment is late.

Medical claim submitters (e.g., medical provider and/or billing offices, etc.) often wait sixty to ninety days after the submission of a medical claim before investigating the status of the claim if the submitter has not received any payment. In some examples, an advanced payment tracker identifies late payments at earlier than sixty days, such as around a twenty day time period, which allows the submitter to follow up on late payments more quickly after the claim has been submitted. Advanced payment tracking helps the provider or billing office substantially reduce an amount of money in Accounts Receivable.

In some examples, the advanced payment tracker uses historical medical claim payment statistics to estimate an expected date to receive payments for claims processed through an electronic data interchange (EDI) clearinghouse (e.g., GE Healthcare's Centricity EDI clearinghouse). The estimated payment date is provided to a user, and the user can identify medical claims that have late payments (e.g., have not received payments by the estimated date). Use of historical payment information provides users with a more accurate estimate of a date and/or time period when claim payment is expected. Advanced payment tracking based on historical payment information allows users to follow up on unpaid claims days or months before users would otherwise. Earlier follow-up helps ensure that unpaid claims are paid sooner, which reduces the time the money appears in Accounts Receivable.

In some examples, the advanced payment tracker helps provide an improved return-on-investment to customers, which helps improve customer satisfaction as well as provide a better sales story. Advanced payment tracking also provides a competitive feature that is not found in other EDI services and which can help to improve sales.

Advanced payment tracking can be implemented as part of an EDI batch of features for claims and remittance processing. Historical payment data is used to provide an estimated payment date and to notify customers when claims are past due. Using a statistical model, an estimated payment date can be determined.

Claim data is input (automatically and/or manually, for example) into a database and/or other data store. When a claim is submitted by a customer (e.g., a hospital, clinic, physician office practice, etc.), the customer can determine when the payer (e.g., an insurance company) typically submits payment (e.g., the first Tuesday after the claim has been submitted), so the advanced payment tracker can build a model for customers. The advanced payment tracker determines when a particular payer is late, which also has implications for clean claim laws (e.g., if a payer is late, a customer can charge interest on those payments).

Several categories can be used for statistical analysis. For example, statistical analysis can be day of the week specific (e.g., Tuesdays are a popular payment day); based on a number of business days after claim submission; based on miscellaneous criteria to model how the payers (e.g., insurance companies) generate their payment cycles, etc.

In some examples, claim status is provided via a website and/or other Internet and/or private network portal. Payment messages (e.g., payment pending, payment complete, payment complete/late (e.g., paid beyond expected completion date), payment pending/late (e.g., create additional detail—zero to three days late, beyond three days late, beyond seven days late, etc.)) can be generated. Payment messages and/or supporting data can be accessed via the website, electronic mail message, and/or pushed down to a practice management system.

In some examples, the advanced payment tracker receives claim and statistic information for a payer and provides a message and overall trend (e.g., report) information for the payer's claim payments. The advanced payment tracker can provide an ability for the customer to provide comments on the message and/or trend output.

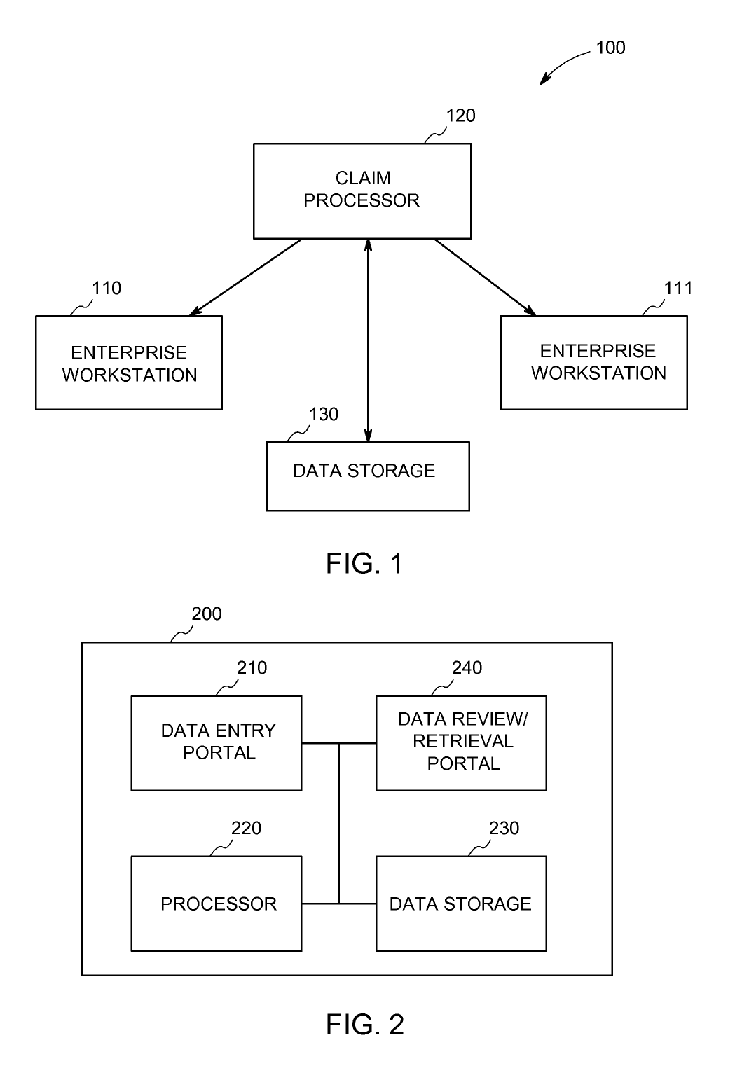

FIG. 1 depicts an example healthcare claim system 100 to receive, process, and remind healthcare claims and remittances. The system 100 includes at least one enterprise workstation 110-111, a claim processor 120, and a data storage 130. The one or more enterprise workstations 110-111 interface with the claim processor 120 to allow a user (e.g., a human user and/or automated software operator) to input and/or retrieve information (e.g., claim and/or remittance information) to/from the claim processor 120 and associated data storage 130. In some examples, a single enterprise workstation 110-111 can be used to both input claim information and remittance information and retrieve results. In some examples, one workstation 110 is used to input claim information and retrieve claim payment status, and another workstation 111 is used to review submitted claim information and input remittance information in response to the submitted claim. The enterprise workstation(s) 110-111, claim processor 120, and data storage 130 can be implemented separately and/or integrated in various combinations of hardware, software, and/or firmware, for example.

In operation, a technician at a clinical facility (e.g., a hospital, clinic, physician office, etc.) inputs a claim. For example, a nurse inputs, via the enterprise workstation 110, a code for a laboratory test to be charged as a claim against the patient's insurance. The claims processor 120 receives the claim and stores the claim in the data storage 130. The claims processor 120 processes the claim, such as by comparing the claim against acceptable procedure codes under the patient's insurance policy and/or other payer guidelines, to determine payability of the claim. If a question arises, the claims processor 120 can trigger an alert (e.g., an electronic message) at the enterprise workstation 110 requesting further information, correction, and/or follow-up from the submitter. If the claim is a proper claim, the claims processor 120 can notify a payer via the enterprise workstation 111 that a claim is awaiting payment. Via the enterprise workstation 111, the payer can review the submitted, pending claim and request additional information and/or authorize payment of the claim. Remittance can be provided via the enterprise workstation 111, for example. In some examples, the claims processor 120 communicates with one or more electronic accounts 140-141 to transfer a remittance to a claim account 140. An account 141 can be associated with one or more payers, and an account 140 can be associated with one or more clinical facilities, healthcare companies, patients, etc.

FIG. 2 depicts an example healthcare claim processing apparatus 200 to receive, process, and generate alerts/reminders for healthcare claims and remittances. The apparatus 200 includes a data entry portal 210, a processor 220, a data storage 230, and a data review/retrieval portal 240. The data entry portal 210, processor 220, data storage 230, and data review/retrieval portal 240 can be implemented separately and/or integrated in various combinations of hardware, software, and/or firmware, for example. For example, the data entry portal 210 can be integrated with the data review/retrieval portal 240.

Via the data entry portal 210, a user (e.g., a human user and/or automated software operator) can input and/or retrieve information (e.g., claim and/or remittance information) to/from the processor 220 and data storage 230. In some examples, a single portal or interface 210, 240 can be used to both input claim information and remittance information and retrieve results. In some examples, the data entry portal 210 is used by a clinician and/or other healthcare practitioner to input claim information and retrieve claim payment status, and the data review/retrieval portal 240 is used by an insurance company agent and/or other payer staff to review submitted claim information and input remittance information in response to the submitted claim.

In operation, a technician at a clinical facility (e.g., a hospital, clinic, physician office, etc.) inputs a claim via the data entry portal 210. For example, a nurse inputs, via the data entry portal 210, a code for a laboratory test to be charged as a claim against the patient's insurance. The processor 220 receives the claim and stores the claim in the data storage 230. The processor 220 processes the claim, such as by comparing the claim against acceptable procedure codes under the patient's insurance policy and/or other payer guidelines, to determine payability of the claim. If a question arises, the processor 220 can trigger an alert (e.g., an electronic message) to request further information, correction, and/or follow-up from the submitter and/or manual review by a payer, for example. If the claim is a proper claim, the processor 220 can notify a payer that a claim is awaiting payment. Via the data review/retrieval portal 240, the payer can review the submitted, pending claim and request additional information and/or authorize payment of the claim. In some examples, the processor 220 communicates with one or more electronic accounts to transfer a remittance to a claim account from a payer account. The processor 220 can calculate a representative period of time elapsed between claim submission and claim remittance, for example. The representative time period can be determined based on a statistical analysis such as an average, median, mode, and/or combination of such statistical values of time elapsed.

Electronic Data Interchange (EDI) services, executed in conjunction with the system 100 and/or apparatus 200 provide proactive support for claims and payment and proactive monitoring that identifies irregularities in claim payment. In some examples, one stop connectivity consolidates electronic claim submission and electronic remittance processing. EDI services provide real-time (including at least substantially real time) connectivity to payers to determine patient eligibility. Information can be brought directly into practice management software and/or systems (e.g., GE Healthcare's Centricity Practice Management) and a claim can be made directly from a practice management tool. The practice management tool can be used to prescreen a claim to identify potential rejections and then submit the claim. A web portal (e.g., the data entry portal 210 and/or data review/retrieval port 240) allows a user to track claims and provides a dashboard for a clinician listing (and providing control) of his/her entire EDI business. Each transaction is monitored while it is being adjudicated by a payer, and clinicians are notified of irregularities or drops.

An explanation of benefits (EOB) file is provided to the clinician and/or to the clinician's patient. An EOB file can be generated when a healthcare provider files a claim for a patient healthcare benefit. An EOB can be used to coordinate payments to healthcare providers.

In some examples, payers are queried to identify potential disruptions in a clinician revenue cycle. Online access is provided to a repository of transactions tracked at a claim, run, and file level through standard and custom reports. Multiple paper reports can be eliminated, and claim follow-up and report reconciliation can be improved.

EDI Services can be used to provide an integrated web-based, comprehensive, all-payer claims management solution via the Internet, for example. EDI services offer state-of-the-art revenue cycle management tools that bridge an all-payer claim EDI gateway, EDI Services, and financial management software. Proactive monitoring services with automated and customized task management work lists are designed to help customers manage the claims that either failed to pass up-front edits or that were denied for payment by payer(s). This combined solution eliminates paper, phone, and fax steps to improve productivity and increase cash flow to save time and money.

Providers can request real-time or batched eligibility requests to be sent to a payer network for immediate response. Responses are stored within the practice management system for review and can be available at all times, for example.

For example, providers may submit HCFA-1500 (and/or other health insurance claim forms) claims electronically to over one thousand health plans connected to the payer network. This eliminates the challenges of maintaining multiple connections with individual trading partners.

Staff provides daily monitoring of all transactions processed through the gateway. The EDI services manage backend partnerships, support, and implementation services for hundreds of customers and millions of transactions. EDI services help ensure through rigorous metric based analysis that claim files are successfully transmitted to the payer, payers have received the claim file and that every claim has been received into the payer's backend adjudication system. Providers can post remittance files from payers to core applications, simplifying the financial reconciliation process.

In some examples, by establishing a single connection through EDI Services, customers are linked electronically to over one thousand payers for the processing of claims and electronic remittance advice. Customers no longer need to expend their own resources to connect directly with numerous individual payers. This one-stop connectivity approach simplifies information exchange and consolidates claim functions such as electronic claim submission, electronic remittance advice processing, paper claims mailing service and outsourcing of patient statements. Using an EDI Services tool, customers are able to see a snapshot of all activity including key billing performance indicators, the value and status of claims processed and the top rejected payers and rejected reasons.

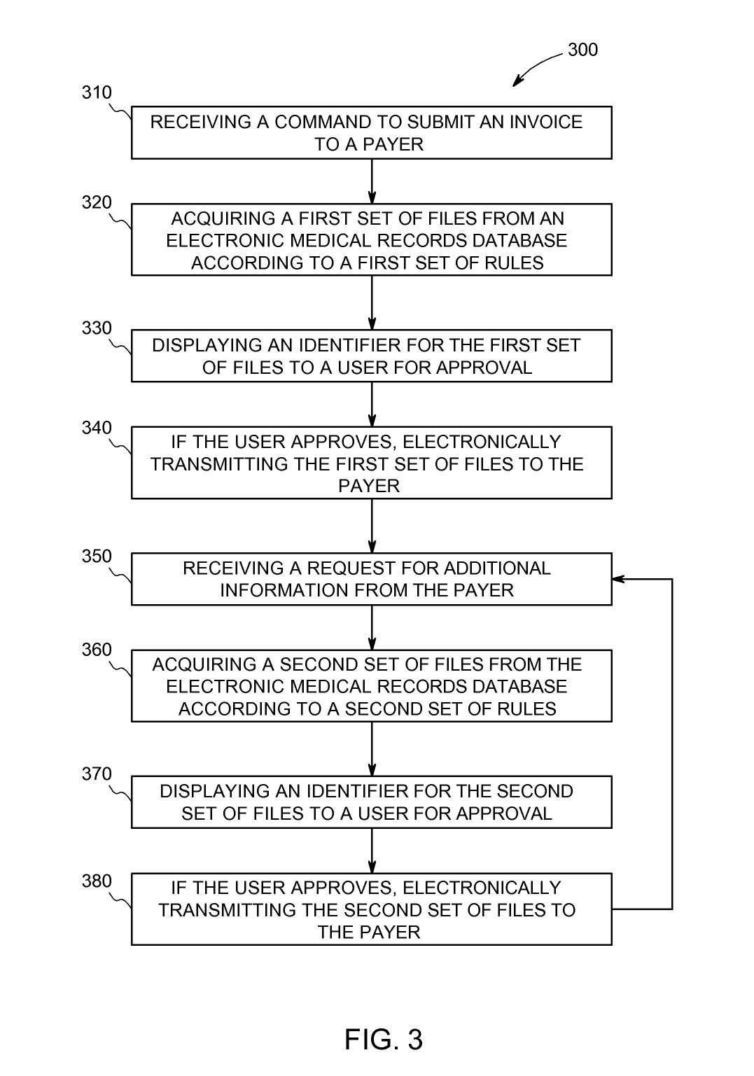

FIG. 3 illustrates a flow diagram for a method 300 to manage clinical documents for claims processing in accordance with an embodiment of the present invention. At block 310, a command to submit an invoice to a payer is received. The command to submit an invoice can include information such as the contact information for the payer. In an example, the payer is an insurance company. For example, the contact information can include an email address. In addition, the invoice can include a claim number, procedure type, patient information, and other information a payer may need to process the claim. In an example, the information in the invoice is coded into a primary tag for the invoice. The primary tag can be used to identify the patient, type of procedure, and the documents associated with the patient and procedure that are relevant to the invoice. The primary tag can be used to associate the invoice with relevant documents and files.

At block 320, a first set of files is acquired from a server according to a first set of rules. In an example, the server can include an electronic medical records database. In an example, the first set of files includes the documents required by the payer for submission of the claim for the patient. For example, the first set of files can include several files that are evidence that procedure X was performed on patient Y. The first set of rules can be defined based on the procedure being submitted. For example, for procedure X, the first set of rules dictate that files A, B, and C be acquired. For procedure Z, the first set of rules dictate that files D, E and F be acquired. The first set of rules is generally defined by the requirements of the payer. In an example, the first set of rules can be different for the same procedure for different payers. For example, if the payer is an insurance company, a patient Y having procedure X and having a payer P1 can have a first set of files comprising A, B, and C. A patient Yl having procedure X and having a payer P2 can have a first set of files comprising A and B. In an example, the primary tag for an invoice is associated with the first set of files. In an example, the primary tag of an invoice is used to acquire the first set of files from an electronic medical records database.

At block 330, once the first set of files is acquired, an identifier for the first set of files is displayed to a user for approval. In an example, the identifier is the title of the first set of files. If the user approves of the files that have been acquired, as in block 340, the files are electronically transmitted to the payer for review. Upon receipt of the files, the payer may find the information sufficient to pay the claim and send payment to the healthcare provider. If the payer does not find the information sufficient to pay the claim, the payer can send a request to the healthcare provider for additional information.

At block 350, a request for additional information from the payer is received. In an example, the request for additional information can include specific requests for certain documents. Alternatively, the request for additional information can include a general request based on the procedure type. At block 360, a second set of files from the electronic medical records database can be acquired according to a second set of rules. In an example, the second set of files can include the files specifically requested by the payer for a particular patient. In such an example, the second set of rules is dictated by the request for additional information. The second set of rules can state to acquire the documents specifically requested. Alternatively, the request for additional information can include a general request based on procedure type. In such an example, the second set of rules dictates a predefined set of documents for a procedure type that provide additional information on the procedure type and evidence for payment. The request for additional documents can include a secondary tag that is used to associate the request with the second set of files. In an example, the second set of files is acquired from an electronic medical records database according to the second set of rules. The second set of rules provide for acquiring a second set of files that supplement the first set of files for submission to the payer. In an example, the second set of files is acquired from the electronic medical records database according to the secondary tag.

At block 370, an identifier for the second set of files can be displayed to a user for approval. In an example, the identifier can include the title of the second set of files for display to the user for approval. If the user approves of the files that have been acquired, as in block 380, the files are electronically transmitted to the payer for review. If the payer finds the second set of files sufficient to pay the claim, the payer can send payment to the healthcare provider. If the payer does not find the information sufficient to pay the claim, the payer can send another request to the healthcare provider for additional information. Blocks 350—350 can repeat until the payer is satisfied, for example.

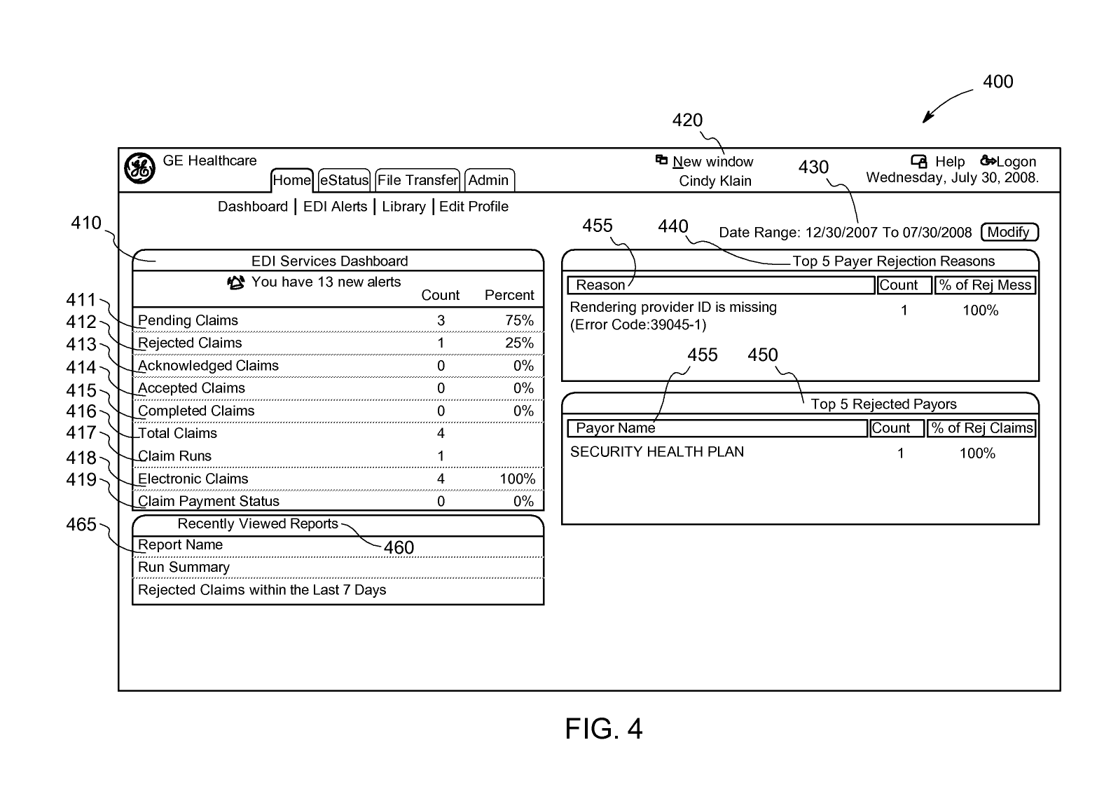

FIG. 4 depicts an example dashboard interface 400 to review pending claim status and other information. The user interface 400 includes an EDI services dashboard 410, a user identifier 420, a specified date range 430, a rejection reasons dashboard 440 including one or more payer rejection reasons 445, a rejected payer dashboard 450 including one or more rejected payer identifiers 455, and a reports tracker 460 including one or more recently viewed reports 465. The EDI services dashboard 410 includes a plurality of entries including pending claims 411, rejected claims 412, acknowledged claims 413, accepted claims 414, completed claims 415, total claims 416, claim runes 417, electronic claims 418, and claim payment status 419, for example.

Using the interface 400, a healthcare provider, for example, can review pending claims, claim payment history, rejected payers, reasons for claim rejection, claim/payment reports, etc. A user 420 can log in and specify a particular date, dates, date range, view all, etc., 430 to view claims, payments, reports, payer information, etc. Using the EDI services dashboard 410, a user can get a high level view of a number of pending claims 411, rejected claims 412, acknowledged claims 413, accepted claims 414, completed claims 415, total claims 416, claim runes 417, electronic claims 418, and claim payment status 419, for example. In some examples, a user can access one or more of the pending claims 411, rejected claims 412, acknowledged claims 413, accepted claims 414, completed claims 415, total claims 416, claim runes 417, electronic claims 418, and claim payment status 419 to drill down and/or link to further information about the summary item.

In some examples, the claim payment status 419 of the EDI services dashboard 410 results from an analysis of expected claim payment based on historical claim submission date and historical claim payment date data, such as the claim payment analysis examples described above. Claim payment status 419 can be used to provide an alert or alarm and/or be used to drill down or link to further information including an alert, alarm, etc., regarding claim payment status versus a claim payment due date and/or expected claim payment date, for example.

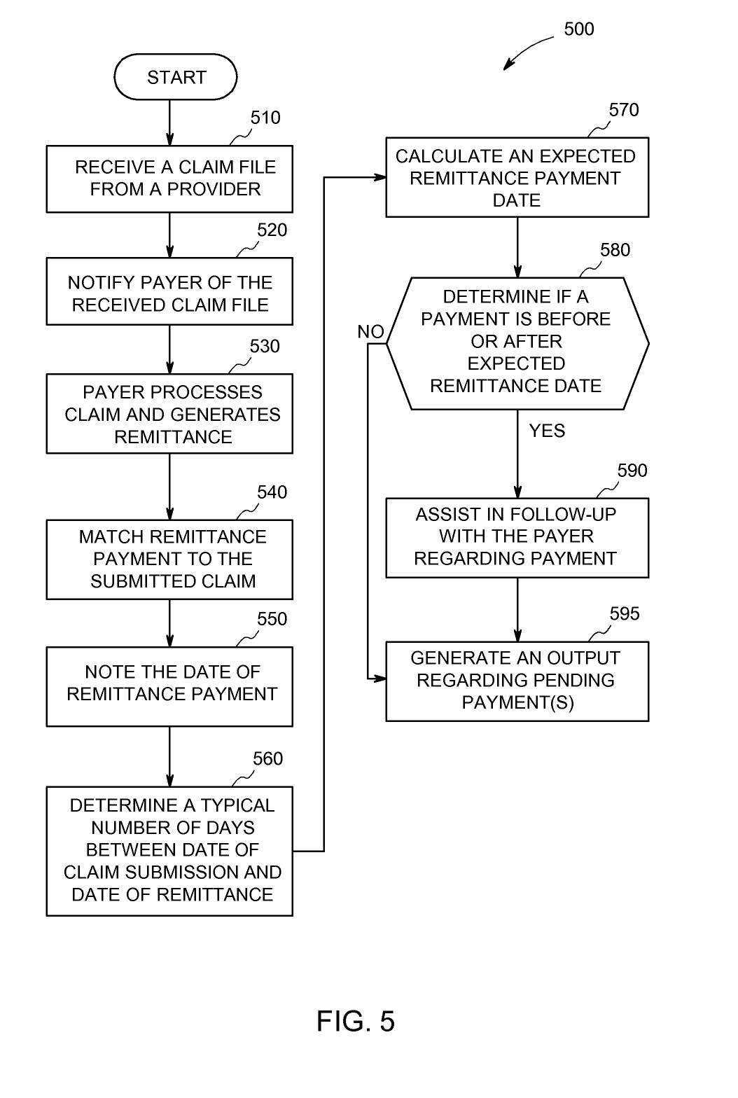

FIG. 5 illustrates a flow diagram of an example method 500 to process filed claim information in a clinical environment. At block 510, a claim file is received from a provider. The date on which the claim file is received is referred to as the date of claim submission. For example, a claim file can be received via the enterprise workstation 110 and/or data entry portal 210. HIPAA Transactions and Code Sets can be used to format claims for submission to a health plan, insurer, and/or other payer, for example.

At block 520, a payer is notified of the received claim file. For example, a payer is sent an email, alert, and/or other message to indicate that a claim has been submitted and is awaiting review and/or payment. For example, the payer can be notified via the enterprise workstation 111, data review/retrieval portal 240, and/or interface 400.

At block 530, the payer processes the claim and generates a remittance. For example, a claim is compared to information and/or criteria such as the claimant's policy, claim enrollment instructions, claim notes, remittance instructions, acceptances, and/or other parameters, criteria, and/or rules to determine whether the claim is a valid claim that qualifies for remittance under the policy. If so, a remittance file is generated by the payer to satisfy the claim. Claim processing and remittance can be generated using the processor 120 and/or 220, for example.

At block 540, once a remittance file has been received from a payer, the specific remittance payment(s) are matched to the submitted claim(s). For example, claim and remittance can be matched by claim number, patient identifier, facility reference, and/or other indicator, for example. Claim and remittance matching can be performed by the processor 120 and/or 220, for example.

At block 550, the date of remittance payment is then noted on the matched claim. For example, a payment field in the claim file can be updated to note the date of remittance payment. For example, the processor 120 and/or 220 can note the date of remittance payment on a stored claim file.

At block 560, a representative typical number of business days between the date of claim submission and the date of remittance payment is determined. For example, the processor 120 and/or 220 calculates a difference between the data of claim submission and the date of remittance payment for the current payment and/or for a series of past submissions and remittances to determine a representative/typical (e.g., average mean, median, median, expected, and/or combination of above, the etc.) number of business days between the date of claim submission and the date of remittance payment.

At block 570, this data is then applied to calculate an expected remittance payment date. For example, based on a date of claim submission and historical payment information (e.g., this payer typically takes 30 business days to remit payment, this payer typically pays on Tuesdays, etc.), an expected remittance payment date for a submitted claim can be calculated. The processor 120 and/or 220 can be used to calculate an expected remittance payment date based on the available data, for example.

At block 580, it is determined if a payment is before or after this date. For example, a current date can be compared to the expected remittance payment date for a submitted claim. The processor 120 and/or 220 can be used to determine whether the payment of a claim is before or after the expected remittance date, for example.

At block 590, an output is generated regarding one or more pending payments. If the current date is before the expected remittance payment date for an unpaid claim, a certain indicator can be generated. For example, the payment indicator can be colored green or be displayed normally with no emphasis. If the current date is after the expected remittance payment date for an unpaid claim, a certain indicator can be generated. For example, the payment indicator for the claim can be colored red and/or otherwise emphasized (e.g., an alarm can be triggered for a user). If the current date is approaching the expected remittance payment date for an unpaid claim, a certain indicator can be generated. For example, the payment indicator for the claim can be colored yellow or orange (e.g., depending upon the proximity to the estimated payment date) and/or otherwise emphasized (e.g., an alert can be triggered for a user). The user, with the help of advance payment tracking, can follow up with payers regarding unpaid claims. For example, claim payment and expected payment date information can be provided via the data entry portal 210, data review/retrieval portal 240, and/or interface 400. The portals 210 and/or 240 and/or another interface (such as the interface 400) can be provided for user access at the enterprise workstations 110 and/or 111, for example. The portals 210, 240 and/or other interface (such as the interface 400) can provide an automated message and/or other alarm/alert to the payer and/or provider as a reminder regarding the unpaid claim and the upcoming due date. The expected remittance date can be used in place and/or in addition to a maximum allotted payment period and/or time period after which additional fees, interest, penalties, etc. start to accrue in order to help facilitate faster remittance and completion of the transaction.

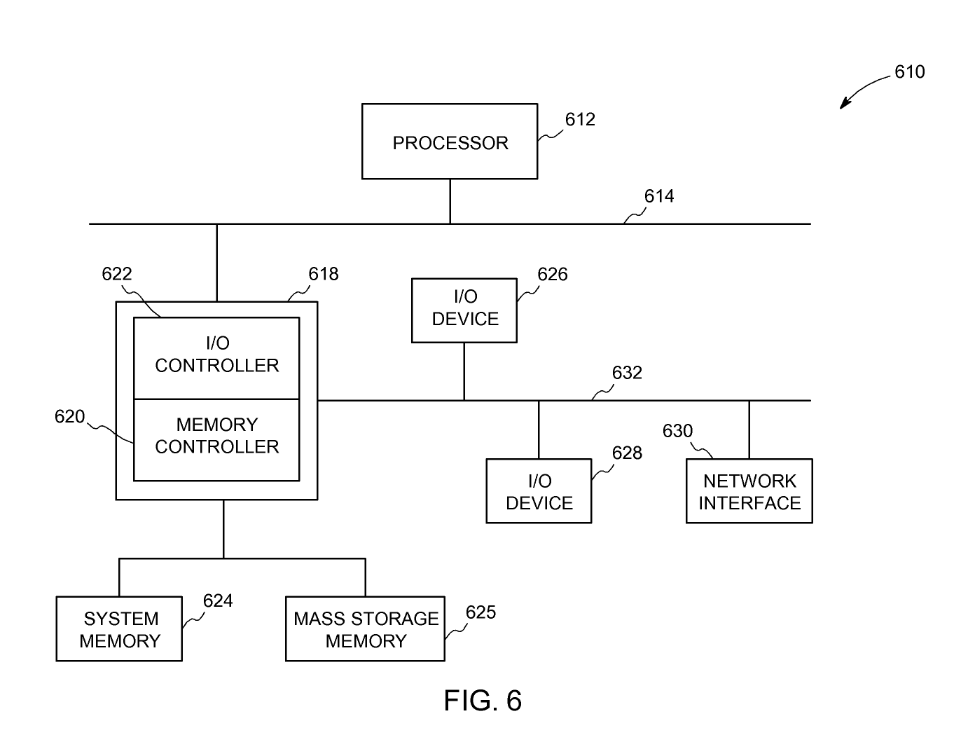

FIG. 6 is a block diagram of an example processor system 610 that may be used to implement systems, apparatus, and methods described herein. As shown in FIG. 6, the processor system 610 includes a processor 612 that is coupled to an interconnection bus 614. The processor 612 may be any suitable processor, processing unit, or microprocessor, for example. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (“I/O”) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (“I/O”) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (“ATM”) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 610 of FIG. 6). When any of the appended claims are read to cover a purely software and/or firmware implementation, at least one of the components is hereby expressly defined to include a tangible medium such as a memory, DVD, CD, etc. storing the software and/or firmware.

FIGS. 3 and 5 include flow diagrams representative of machine readable and executable instructions or processes that can be executed to implement the example systems, apparatus, and article of manufacture described herein. The example processes of FIGS. 3 and 5 can be performed using a processor, a controller and/or any other suitable processing device. For example, the example processes of FIGS. 3 and 5 can be implemented in coded instructions stored on a tangible medium such as a flash memory, a read-only memory (ROM) and/or random-access memory (RAM) associated with a processor (e.g., the processor 612 of FIG. 6). Alternatively, some or all of the example processes of FIGS. 3 and 5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3 and 5 can be implemented manually or as any combination(s) of any of the foregoing techniques, for example, any combination of firmware, software, discrete logic and/or hardware. Further, although the example processes of FIGS. 3 and 5 are described with reference to the flow diagrams of FIGS. 3 and 5, other methods of implementing the processes of FIGS. 3 and 5 can be employed. For example, the order of execution of the blocks may be changed, and/or some of the blocks described may be changed, eliminated, sub-divided, or combined. Additionally, any or all of the example processes of FIGS. 3 and 5 can be performed sequentially and/or in parallel by, for example, separate processing threads, processors, devices, discrete logic, circuits, etc.

One or more of the components of the systems and/or blocks of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method blocks and/or perform the blocks in a different order than the order listed. For example, some blocks may not be performed in certain embodiments of the present invention. As a further example, certain blocks may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method to process healthcare claim submission and payment, said method comprising:
retrieving historical data regarding healthcare claim submission and payment dates from a data store via a computer, the historical data including one or more dates of claim submission and one or more corresponding dates of remittance payment;
generating, using a computer processor, a value for a representative period of time elapsed between date of claim submission and date of remittance payment based on the historical data for a payer, the value transforming the historical data regarding dates of claim submission and remittance payment into a representative elapsed time period;
automatically applying the representative period of time to each submitted claim for the payer available for provider review via a dashboard interface to calculate an expected remittance payment date for each submitted claim using the computer processor;
determining if a payment for each submitted claim is before or after the expected remittance payment date for the submitted claim;
displaying the expected remittance payment date for each submitted claim via the dashboard interface;
translating the determining if a payment for each submitted claim is before or after the expected remittance payment date for the submitted claim into a payment status message to the provider for at least one submitted claim to indicate a past due payment or a pending payment approaching the expected remittance payment date for the submitted claim; and
facilitating, via the dashboard interface, contact by the provider to the payer associated with a submitted claim to inquire about payment remittance for the submitted claim.

2. The method of claim 1, wherein the historical data are obtained via a method for claim submission and remittance comprising:
receiving, on a date of claim submission, a claim for a healthcare service performed for a patient by a healthcare provider via a user portal at a provider computer;
receiving, on a date of remittance payment, a remittance paying for a healthcare service via a payer computer; and
matching the claim with the remittance using a claims processor.

3. The method of claim 1, further comprising providing a trend report for remittance payment by a payer to the provider via the dashboard interface.

4. The method of claim 1, wherein the payment status message comprises at least one of an electronic message sent to the provider via the dashboard interface and visual emphasis of at least one submitted claim for provider attention via the dashboard interface.

5. The method of claim 1, wherein the payment status message for a submitted claim is transmitted to the corresponding payer.

6. The method of claim 1, wherein the payment status message comprises at least one of paid beyond expected date and payment pending late.

7. The method of claim 1, wherein the payment status message is pushed to a provider practice management system.

8. The method of claim 1, wherein the data store is included in an electronic data interchange.

9. The method of claim 1, wherein generating, using a computer processor, a value for a representative period of time elapsed between date of claim submission and date of remittance payment based on the historical data for a payer further comprises applying one or more categories for statistical analysis to the historical data, the categories including day of the week, business days after claim submission, and insurance company payment cycle modeling.

10. A tangible, computer readable storage medium including a set of instructions for execution by a computer, said set of instructions comprising:
a data store to store historical data regarding healthcare claim submission and payment dates from a data store via a computer, the historical data including one or more dates of claim submission and one or more corresponding dates of remittance payment;
a claims processor to generate a value for a representative period of time elapsed between date of claim submission and date of remittance payment based on the historical data for a payer, the value transforming the historical data regarding dates of claim submission and remittance payment into a representative elapsed time period, wherein the claims processor is to apply the representative period of time to each submitted claim for the payer available for provider review to calculate an expected remittance payment date for each submitted claim and determine if a payment for each submitted claim is before or after the expected remittance payment date for the submitted claim, and wherein the claims processor is to translate the determination of if a payment for each submitted claim is before or after the expected remittance payment date for the submitted claim into a payment status message to the provider for at least one submitted claim to indicate a past due payment or a pending payment approaching the expected remittance payment date for the submitted claim; and
a dashboard interface to display the expected remittance payment date for each submitted claim for a provider, the dashboard interface to facilitate contact by the provider with the payer associated with a submitted claim to inquire about payment remittance for the submitted claim.

11. The tangible, computer readable storage medium of claim 10, wherein the payment status message comprises at least one of an electronic message sent to the provider via the dashboard interface and visual emphasis of at least one submitted claim for provider attention via the dashboard interface.

12. A healthcare claim payment tracking system, said system comprising:
a data store to store historical data regarding healthcare claim submission and payment dates from a data store via a computer, the historical data including one or more dates of claim submission and one or more corresponding dates of remittance payment;
a claims processor to generate a value for a representative period of time elapsed between date of claim submission and date of remittance payment based on the historical data for a payer, the value transforming the historical data regarding dates of claim submission and remittance payment into a representative elapsed time period, wherein the claims processor is to apply the representative period of time to each submitted claim for the payer available for provider review to calculate an expected remittance payment date for each submitted claim and determine if a payment for each submitted claim is before or after the expected remittance payment date for the submitted claim, and wherein the claims processor is to translate the determination of if a payment for each submitted claim is before or after the expected remittance payment date for the submitted claim into a payment status message to the provider for at least one submitted claim to indicate a past due payment or a pending payment approaching the expected remittance payment date for the submitted claim; and
a dashboard interface to display the expected remittance payment date for each submitted claim for a provider, the dashboard interface to facilitate contact by the provider with the payer associated with a submitted claim to inquire about payment remittance for the submitted claim.

13. The system of claim 12, wherein the data store is to obtain the historical data by receiving, on a date of claim submission, a claim for a healthcare service performed for a patient by a healthcare provider via a user portal at a provider computer; receiving, on a date of remittance payment, a remittance paying for a healthcare service via a payer computer; and matching the claim with the remittance using the claims processor.

14. The system of claim 12, wherein the claims processor and dashboard interface are to provide a trend report for remittance payment by a payer to the provider via the dashboard interface.

15. The system of claim 12, wherein the payment status message comprises at least one of an electronic message sent to the provider via the dashboard interface and visual emphasis of at least one submitted claim for provider attention via the dashboard interface.

16. The system of claim 12, wherein the payment status message for a submitted claim is transmitted to the corresponding payer.

17. The system of claim 12, wherein the payment status message comprises at least one of paid beyond expected date and payment pending late.

18. The system of claim 12, wherein the payment status message is pushed to a provider practice management system.

19. The system of claim 12, wherein the data store is included in an electronic data interchange.

20. The system of claim 12, wherein the claims processor is to apply one or more categories for statistical analysis to the historical data to generate a value for a representative period of time elapsed between date of claim submission and date of remittance payment based on the historical data for a payer, the categories including day of the week, business days after claim submission, and insurance company payment cycle modeling.
